(19) United States
(12) Patent Application Publication
(10) Pub. No.: US 2023/0206139 A1
(43) Pub. Date: Jun. 29, 2023

(54) RECOMMENDING CHARGING STATION AND DETERMINING STATE OF CHARGING PILE

(71) Applicant: BEIJING BAIDU NETCOM SCIENCE TECHNOLOGY CO., LTD., Beijing (CN)

(72) Inventor: Xin ZHANG, BEIJING (CN)

(21) Appl. No.: 18/111,367

(22) Filed: Feb. 17, 2023

(30) Foreign Application Priority Data
Mar. 2, 2022 (CN) 202210201782.X

(51) Int. Cl. G06Q 10/02

(52) U.S. Cl. CPC G06Q 10/02

(57) ABSTRACT

A method and an apparatus for recommending a charging station, and a method and an apparatus for determining a state of a charging pile are provided. An implementation includes: determining a set of candidate charging stations for a target vehicle; determining, for each candidate charging station in the set of candidate charging stations, an estimated time of arrival of the target vehicle, and obtaining an estimated state of a charging pile. The estimated state of the charging pile of the candidate charging station is based on a current state of the charging pile and charging reservation information, and the charging reservation information includes: an estimated time of charging and estimated duration of charging of a vehicle to be charged that has reserved the candidate charging station. The implementation further includes determining a target charging station according to the estimated states of the charging piles.

### CROSS REFERENCE TO RELATED APPLICATIONS

This application claims priority to Chinese Patent Application No. 202210201782.X, filed on Mar. 2, 2022, the contents of which are hereby incorporated by reference in their entirety for all purposes.

### TECHNICAL FIELD

The present disclosure relates to the field of computer technology, and in particular to the field of intelligent transportation technology.

### BACKGROUND

Vehicles are important mode of transportation for people to travel. At present, new energy vehicles, that is, electric vehicles, have become more and more popular, but disadvantages thereof are also obvious: the electric vehicles cannot continuously travel for a long distance, and have a long charging duration.

When a new energy vehicle needs to be charged, it is very important to properly recommend a charging station for the vehicle owner for traveling experience of a vehicle owner.

### SUMMARY

The present disclosure provides a method and an apparatus for recommending a charging station, and a method and an apparatus for determining a state of a charging pile.

According to an aspect of the present disclosure, a method for recommending a charging station is provided that includes:

determining a set of candidate charging stations for a target vehicle;

determining, for each candidate charging station in the set of candidate charging stations, an estimated time of arrival of the target vehicle, and obtaining an estimated state of a charging pile of the candidate charging station at the estimated time of arrival, wherein the estimated state of the charging pile of the candidate charging station is based on a current state of the charging pile and charging reservation information, and wherein the charging reservation information includes: an estimated time of charging and estimated duration of charging of a vehicle to be charged that has reserved the candidate charging station; and

determining a target charging station from the set of candidate charging stations according to the obtained estimated states of the charging piles of the candidate charging stations in the set of candidate charging stations at the estimated times of arrival of the target vehicle, and recommending the target charging station for charging the target vehicle.

According to another aspect of the present disclosure, a method for determining a state of a charging pile is provided that includes:

determining charging reservation information of one or more vehicles to be charged that have reserved a target charging station, wherein the charging reservation information for a given vehicle includes: an estimated time of charging the given vehicle and estimated duration of charging the given vehicle;

determining an estimated state of the charging pile of the target charging station corresponding to a preset future period according to a current state of the charging pile of the target charging station and the charging reservation information of the one or more vehicles to be charged.

According to another aspect of the present disclosure, an electronic device is provided that includes:

at least one processor; and

a memory in communication with the at least one processor, where

the memory stores instructions executable by the at least one processor that, when executed by the at least one processor, cause the at least one processor to perform the method for recommending a charging station or the method for determining a state of a charging pile.

According to another aspect of the present disclosure, a non-transitory computer-readable storage medium storing computer instructions is provided, where the computer instructions, when executed by one or more processors, cause a computer to perform the method for recommending a charging station or the method for determining a state of a charging pile.

It should be appreciated that the content described in this section is not intended to identify critical or important features of the embodiments of the present disclosure, nor is it intended to limit the scope of the present disclosure. Other features of the present disclosure will be easily understood from the following description.

### BRIEF DESCRIPTION OF THE DRAWINGS

The accompanying drawings are for a better understanding of the solutions, and do not constitute a limitation on the present disclosure. In the accompanying drawings:

FIG. 1 is a schematic flowchart of a method for recommending a charging station according to an embodiment of the present disclosure;

FIG. 2 is a schematic flowchart of a method for determining a state of a charging pile according to an embodiment of the present disclosure;

FIG. 3 is a first schematic diagram of a state of a charging pile according to an embodiment of the present disclosure;

FIG. 4 is a second schematic diagram of a state of a charging pile according to an embodiment of the present disclosure;

FIG. 5 is a third schematic diagram of a state of a charging pile according to an embodiment of the present disclosure;

FIG. 6 is a fourth schematic diagram of a state of a charging pile according to an embodiment of the present disclosure;

FIG. 7 is a block diagram of an apparatus configured to implement a method for recommending a charging station according to an embodiment of the present disclosure;

FIG. 8 is a block diagram of an apparatus configured to implement a method for determining a state of a charging pile according to an embodiment of the present disclosure; and

FIG. 9 is a block diagram of an electronic device according to an embodiment of the present disclosure.

### DETAILED DESCRIPTION OF EMBODIMENTS

Example embodiments of the present disclosure are described below in combination with the accompanying drawings, where various details of the embodiments of the present disclosure are included to facilitate understanding, and should only be considered as exemplary. Therefore, those of ordinary skill in the art should recognize that various changes and modifications can be made to the embodiments described herein, without departing from the scope and spirit of the present disclosure. Likewise, the description of well-known functions and structures is omitted in the following description for clarity and conciseness.

Vehicles are important mode of transportation for people to travel. At present, new energy vehicles, that is, electric vehicles, have become more and more popular, but disadvantages thereof are also obvious: the electric vehicles cannot continuously travel for a long distance, and have a long charging duration.

When a new energy vehicle needs to be charged, it is very important to properly recommend a charging station for the vehicle owner for traveling experience of a vehicle owner.

In existing solutions for recommending a charging station, a charging station within a reachable range for the remaining mileage is determined based on a current state of charge of a vehicle, and is recommended in combination with dynamic data of the charging station. The dynamic data refers to: states of all charging piles in the charging station, for example, whether the charging piles are open to the public, idle/occupancy/queuing situation, and adaptive vehicle models.

In solutions for recommending a charging station, an occupied/queuing situation of the charging piles is particularly important for the traveling experience of the vehicle owner. If a charging station is recommended for the vehicle owner that requires the vehicle owner to queue up, a huge travel time cost will be caused in the case that it requires 1-2 hours for charging in addition to a queuing time, thereby inevitably lowering traveling satisfaction of the vehicle owner. In the existing solutions for recommending a charging station, only a current dynamic state of the charging station is considered, but a state of the charging pile is not predicted when the vehicle owner navigates to the charging station. Therefore, it may occurs that when the vehicle initiates a navigation, there may be idle charging piles in the charging station, but when the vehicle arrives at the charging station, the charging piles may be occupied.

For example, there are three charging piles in the charging station, the current states of which are idle state. At a certain time, a vehicle A initiates route planning. According to an existing algorithm for recommending a charging pile, there is a high probability that the vehicle will be planned to go to this charging station for charging, since there are idle pile positions in this charging station which is close to the vehicle A. However, when the vehicle A arrives, it is found that a vehicle B, a vehicle C, and a vehicle D have already arrived for charging; and since the vehicle B, the vehicle C, and the vehicle D have just started to charge, at least 1 hour of queuing is required. As a result, a very poor experience and unnecessary queuing are brought to the owner of the vehicle A.

To reduce a time cost of the vehicle charging and optimize the traveling experiences of the owners of the electric vehicles, a method and an apparatus for recommending a charging station and a method and an apparatus for updating a state of a charging pile are provided in the present disclosure.

According to an embodiment of the present disclosure, a method for recommending a charging station is provided that includes:

determining candidate charging stations for a target vehicle;

determining, for each candidate charging station, an estimated time of arrival of the target vehicle, and obtaining an estimated state of a charging pile of the candidate charging station at the estimated time of arrival, where the estimated state of the charging pile is determined according to a current state of the charging pile and charging reservation information, and the charging reservation information includes: an estimated time of charging and estimated duration of charging of a vehicle to be charged that has reserved the candidate charging station; and

determining a target charging station from the candidate charging stations according to the obtained estimated states of the charging piles of each candidate charging station at the estimated time of arrival of the target vehicle, and recommending the target charging station for the target vehicle.

It can be seen that, in the embodiment of the present disclosure, the charging station determines the estimated state of the charging pile corresponding to the preset future period based on the current state of the charging pile and the charging reservation information of the vehicle to be charged that has reserved the charging station. In combination with the estimated time when the target vehicle arrives at each candidate charging pile, the estimated state of the charging pile of each candidate charging station at respective estimated time of arrival (i.e., an estimated idle/occupied/queuing state of the charging pile when the target vehicle arrives) can be determined. Compared with the recommendation method based only on the current state of the charging pile of the candidate charging station, the recommendation method according to the present disclosure is more proper, so that the case can be avoided as much as possible where there are idle charging piles when the vehicle initiates navigation, but the charging piles are occupied when the vehicle arrives at the charging station. Unnecessary queuing of the owner of the electric vehicle is reduced as much as possible, a time cost of vehicle charging is decreased, and traveling experience of the owner of the electric vehicle is optimized.

The method for recommending a charging station according to the embodiments of the present disclosure will be described in detail below.

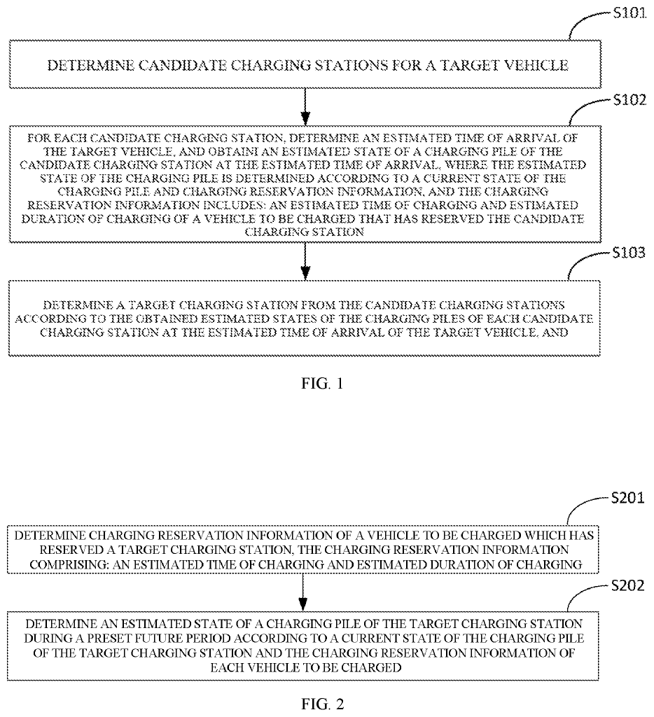

Referring to the figures, FIG. 1 is a schematic flowchart of a method for recommending a charging station according to an embodiment of the present disclosure. As shown in FIG. 1, the method may include the following steps:

S101: determining candidate charging stations for a target vehicle.

In the embodiments of the present disclosure, the target vehicle is a new energy vehicle that needs charging station recommendation.

The method for recommending a charging station according to the embodiments of the present disclosure may be applied to vehicle-machine systems, or may be applied to servers of map applications running on the vehicle-machine systems.

As an example, when the vehicle-machine system detects that the state of charge of the vehicle is low, the vehicle is determined as the target vehicle, and the candidate charging stations are determined.

As an example, when the vehicle owner actively searches for a surrounding charging station or a charging station near a point of interest (POI) via the vehicle-machine system or the map application running on the vehicle-machine system, the vehicle-machine system or the map application running on the vehicle-machine system determines the vehicle as the target vehicle, and the candidate charging station are determined.

The candidate charging stations may be charging stations in the current city, around the current position, around the POI and/or matching a vehicle model of the target vehicle.

S102: determining, for each candidate charging station, an estimated time of arrival of the target vehicle, and obtaining an estimated state of a charging pile of the candidate charging station at the estimated time of arrival, where the estimated state of the charging pile is determined according to a current state of the charging pile and charging reservation information, and the charging reservation information includes: an estimated time of charging and estimated duration of charging of a vehicle to be charged that has reserved the candidate charging station.

In the embodiment of the present disclosure, after the candidate charging stations are determined, the estimated time of arrival (ETA) of the target vehicle to any candidate charging station may be determined, where reference may be made to the related art for the method for determining the ETA, and details are not described herein.

In the embodiment of the present disclosure, each candidate charging station maintains the estimated states of the charging piles in the station. The estimated state of the charging stations may be an estimated idle/occupied/queuing state of the charging pile during a preset future period.

The preset future period may be set according to needs, for example, set to be two hours in the future.

The estimated state of the charging pile is determined according to the current state of the charging pile and charging reservation information. The charging reservation information includes: the estimated time of charging and estimated duration of charging of the vehicle to be charged that has reserved the candidate charging station.

Specifically, when the vehicle to be charged has reserved a certain candidate charging station, this candidate charging station can obtain the charging reservation information of the vehicle to be charged, which includes the estimated time of charging and the estimated duration of charging.

The estimated time of charging may be the estimated time of arrival when the vehicle to be charged arrives at the candidate charging station.

In an embodiment of the present disclosure, an estimated charging quantity of the vehicle to be charged when it arrives at the candidate charging station is divided by a charging rate of the charging pile to obtain the estimated duration of charging, where the estimated charging quantity may be a difference between an electric quantity when the vehicle is fully charged and an estimated state of charge when the vehicle to be charged arrives at the candidate charging station.

Therefore, the candidate charging station may determine the estimated state of the charging pile during the future period based on the current state of the charging pile and the charging reservation information.

For example, it is assumed that the current time is 12:00, and a candidate charging station A includes two charging piles, the current states of which are idle. If the candidate charging station A obtains the charging reservation information of a vehicle a to be charged at the current time, where the charging reservation information indicates that the estimated time of charging is 12:30 and the estimated duration of charging is 1 hour, estimated states of the charging piles are updated as follows: during 12:00-12:30, the two charging piles are both idle; during 12:30-13:30, one charging pile is idle, and the other one is occupied; and after 13:30, the two charging piles are both idle.

At 12:20, the candidate charging station A obtains the charging reservation information of a vehicle b to be charged, where the charging reservation information indicates that the estimated time of charging is 13:00 and the estimated duration of charging is 1 hour. The estimated states of the charging piles are updated again as follows: during 12:00-12:30, the two charging piles are both idle; during 12:30-13:00, one charging pile is idle, and the other one is occupied; during 13:00-13:30, the two charging piles are both occupied; during 13:30-14:00, one charging pile is idle, and the other one is occupied; and after 14:00, the two charging piles are both idle.

It can be seen that, in the embodiment of the present disclosure, each candidate charging station may update the estimated states of the charging piles during the future period in real time according to the current states of the charging piles and the charging reservation information.

In the process of recommending a charging station for the target vehicle, the estimated states of the charging piles of each candidate charging station at respective estimated time of arrival may be determined after the estimated time of arrival of the target vehicle is determined.

Following the above described example, if the estimated time of arrival when the target vehicle arrives at the candidate charging station A is 13:40, according to the estimated states of the charging piles of the candidate charging station A, it may be determined that one charging pile in the candidate charging station A is idle and the other one is occupied when the target vehicle arrives at the candidate charging station A. That is, if the candidate charging station A is selected as the target charging station, it is expected that there is no need to queue when the target vehicle arrives at the charging station.

S103: determining a target charging station from the candidate charging stations according to the obtained estimated states of the charging piles of each candidate charging station at the estimated time of arrival of the target vehicle, and recommending the target charging station for the target vehicle.

In the embodiment of the present disclosure, based on the obtained estimated states of the charging piles of each candidate charging station at the estimated time of arrival of the target vehicle, information may be determined such as whether the target vehicle needs to queue up and the number of idle charging piles when the target vehicle arrives at each candidate charging station. On this basis, the target charging station may be determined.

For example, the candidate charging station with the largest number of charging piles in idle state among the estimated states of the charging piles is selected as the target charging station.

It can be seen that, in the embodiment of the present disclosure, the charging station determines the estimated state of the charging pile corresponding to the preset future period based on the current state of the charging pile and the charging reservation information of the vehicle to be charged that has reserved the charging station. In combination with the estimated time when the target vehicle arrives at each candidate charging pile, the estimated state of the charging pile of each candidate charging station at respective estimated time of arrival (i.e., an estimated idle/occupied/queuing state of the charging pile when the target vehicle arrives) can be determined. Compared with the recommendation method based only on the current state of the charging pile of the candidate charging station, the recommendation method according to the present disclosure is more proper, so that the case can be avoided as much as possible where there are idle charging piles when the vehicle initiates navigation, but the charging piles are occupied when the vehicle arrives at the charging station. Unnecessary queuing up of the owner of the electric vehicle is reduced as much as possible, a time cost of vehicle charging is decreased, and traveling experience of the owner of the electric vehicle is optimized.

In an embodiment of the present disclosure, in order to further reduce the time cost of vehicle charging and optimize the traveling experience of the owner of the electric vehicle, a time cost for charging of the target vehicle going to each candidate charging station for charging may be calculated.

The method may further include the following steps:

determining, for each candidate charging station, estimated duration of traveling and estimated duration of charging of the target vehicle going to the candidate charging station for charging, where the estimated duration of charging is determined according to the estimated charging quantity of the target vehicle when it arrives at the candidate charging station.

Firstly, for each candidate charging station, the estimated duration of traveling of the target vehicle going to the candidate charging station for charging is determined. Specifically, the estimated duration of traveling is a difference between the current time and the ETA.

Additionally, the estimated charging quantity of the target vehicle when it arrives at the candidate charging station is determined. The estimated duration of charging may be obtained by dividing the estimated charging quantity by a charging rate of the charging pile of the candidate charging station. The estimated charging quantity may be a difference between an electric quantity when the vehicle is fully charged and an estimated state of charge when the vehicle to be charged arrives at the candidate charging station.

Accordingly, Step S103 of determining the target charging station from the candidate charging stations according to the obtained estimated states of the charging piles of each candidate charging station at the estimated time of arrival of the target vehicle may specifically include:

Step 11: determining, for each candidate charging station, estimated duration of queuing of the target vehicle going to the candidate charging station for charging according to the obtained estimated states of the charging piles of the candidate charging station at the estimated time of arrival of the target vehicle.

The estimated state of the charging pile can characterize the estimated number of charging piles in the occupied state and the estimated number of charging piles in the idle state when the target vehicle arrives at the candidate charging station. For the charging piles in the estimated occupied state, the estimated state of the charging pile also represents estimated remaining duration of charging and/or the number of vehicles in queue.

Therefore, the estimated duration of queuing of the target vehicle going to the candidate charging station for charging may be determined based on the estimated state of the charging pile.

As an example, if the estimated state of the charging pile indicates that the estimated number of the charging piles in the idle state is greater than 1, it indicates that the target vehicle is estimated not to queue up when arriving at the candidate charging station, that is, the estimated duration of queuing is 0.

As an example, if the estimated state of the charging pile indicates that the estimated number of the charging piles in the idle state is 0, and the minimum estimated remaining duration of charging is 30 minutes for the charging piles estimated to be in the occupied state without queued vehicles, the estimated duration of queuing of the target vehicle going to the candidate charging station for charging is 30 minutes.

Step 12: determining a time cost of charging of the target vehicle going to each candidate charging station for charging according to the estimated duration of traveling, the estimated duration of queuing, and the estimated duration of charging.

Step 13: selecting the target charging station from the candidate charging stations based on the time cost of charging.

Specifically, for each candidate charging station, the estimated duration of traveling for going to the candidate charging station, the estimated duration of queuing after arriving at the candidate charging station and the estimated duration of charging for charging at the candidate charging station are added as the time cost of charging for going to the candidate charging station for charging.

It can be seen that, in the embodiment of the present disclosure, the time cost of charging of the target vehicle going to each candidate charging station for charging is estimated, and the time cost of charging is considered as an important factor for recommending the target charging station. As a result, the time cost for charging the vehicle can be further reduced, and traveling experience of the owner of the electric vehicle is optimized.

In an embodiment of the present disclosure, a charging station with a minimum time cost of charging is selected from the candidate charging stations as the target charging station.

It can be seen that, since the time cost of charging of the target vehicle going to each candidate charging station for charging is determined, directly selecting the charging station with the minimum time cost of charging can reduce the time cost for charging the vehicle as much as possible, and optimize the traveling experience of the owner of the electric vehicle.

In an embodiment of the present disclosure, in addition to the time cost of charging, other factors of the candidate charging station may also be comprehensively considered, such as a position evaluation parameter, a vehicle owner preference parameter, and a total number of charging piles. These factors may be defined as recommendation factors.

The position evaluation parameter is used to characterize the quality of the geographic position of the charging station, a value of which may be defined between 0 and 1. For example, the position evaluation parameter of a charging station located at a remote position is closer to 0. The vehicle owner preference parameter is used to characterize a preference of the owner of the target vehicle for different types of charging stations, a value of which may also be defined between 0 and 1.

The recommendation factors may be pre-collected and stored.

After the time cost of charging of each candidate charging station is determined, for each candidate charging station, the time cost of charging and the recommendation factors of the candidate charging station are input to a pre-trained recommendation model to obtain a recommendation score for the candidate charging station.

The recommendation model may be a ranking model such as a logistic regression model, or an Extreme Gradient Boosting (xgboost) model, and may be trained based on the pre-collected recommendation samples.

For example, a recommendation result that is adopted by the vehicle owner to actually arrive at the charging station to complete charging is marked as a positive sample. A recommendation result is marked as a negative sample when the vehicle owner does not adopt the recommendation result but changes to another charging station and the actual time cost of charging is less than the estimated time cost of charging. Then, the recommendation model is trained based on a large number of positive and negative samples.

It can be seen that, in the embodiment of the present disclosure, the time cost of charging, the position evaluation parameter, the vehicle owner preference parameter, the total number of charging piles, etc. are used as features to pre-train the ranking model. As a result, recommending the charging stations with the pre-trained ranking model can consider various factors, such that a charging station is recommended which is more complying with the needs of the vehicle owner and traveling experience of the owner of the electric vehicle is further optimized.

Referring to FIG. 2, FIG. 2 is a schematic flowchart of a method for determining a state of a charging pile according to an embodiment of the present disclosure. As shown in FIG. 2, the method includes the following steps:

S201: determining charging reservation information of a vehicle to be charged that has reserved a target charging station, the charging reservation information including: an estimated time of charging and estimated duration of charging.

In the embodiment of the present disclosure, whenever a vehicle has reserved the target charging station, the vehicle is determined as the vehicle to be charged, and the charging reservation information is determined including the estimated time of charging and the estimated duration of charging.

Specifically, the estimated time at which the vehicle to be charged arrives at the target charging station may be calculated as the estimated time of charging.

Additionally, an estimated charging quantity of the vehicle to be charged arriving at the target charging station is obtained. The estimated charging quantity may be a difference between an electric quantity when the vehicle to be charged is fully charged and an estimated state of charge when the vehicle to be charged arrives at the charging station.

As an example, an estimated charging quantity sent by the vehicle-machine system of the vehicle to be charged is received. The estimated duration of charging may be obtained by dividing the estimated charging quantity by a charging rate of the charging pile of the target charging station.

S202: determining an estimated state of the charging pile of the target charging station during a preset future period according to a current state of the charging pile of the target charging station and the charging reservation information of each vehicle to be charged.

The method for determining the state of the charging pile according to the embodiments of the present disclosure may be applied to servers of target map applications, or may be applied to electronic devices maintaining the state of the charging piles in the charging stations, that are connected to the servers of the target map applications.

As an example, according to the embodiment of the present disclosure, the method for determining the state of the charging pile is applied to the server of the target map application. The server of the target map application may receive the current state of the charging pile sent by the target charging station, and in combination with the charging reservation information of each vehicle to be charged that has reserved the target charging station, the estimated state of the charging pile of the target charging station corresponding to the preset future period may be determined.

In the embodiment of the present disclosure, the current state of the charging pile includes: an idle/occupied/queuing state of the current charging pile. When the charging pile is in the occupied state, the current state of the charging pile further includes an estimated duration of occupancy. For the step of determining the estimated state of the charging pile corresponding to the preset future period according to the current state of the charging pile and the charging reservation information, reference may be made to the above, and details are not described herein.

It can be seen that, in the embodiment of the present disclosure, the charging reservation information including the estimated time of charging and the estimated duration of charging is determined for the vehicle to be charged that has reserved the target charging station. Moreover, according to the current state of the charging pile of the target charging station and the charging reservation information of each vehicle to be charged that has reserved the target charging station, the estimated state of the charging pile of the target charging station corresponding to the preset future period (i.e., the estimated idle/occupied/queuing state of the charging pile corresponding to the preset future period) is determined. Therefore, when recommending a charging station for the target vehicle, it is more proper to use the estimated state of the charging pile corresponding to the preset future period as the reference factor, compared with the recommendation method that only uses the current state of the charging pile as the reference factor. The situation can be avoided as much as possible where there are idle charging piles in the charging station when the vehicle initiates navigation, but the charging piles are all occupied when the vehicle arrives at the charging station. Unnecessary queuing up of the owner of the electric vehicle is reduced as much as possible, the time cost of vehicle charging is decreased, and traveling experience of the owner of the electric vehicle is optimized.

In an embodiment of the present disclosure, step S201 of determining the charging reservation information of the vehicle to be charged that has reserved the target charging station may include:

determining, when a route navigation initiated on the target map application having the target charging station as the destination is detected, the vehicle that initiates the route navigation as the vehicle to be charged that has reserved the target charging station, and determining the charging reservation information of the vehicle to be charged.

Specifically, whenever a vehicle initiates a route navigation with any target charging station as a destination on the target map application, a server of the target map application determines the vehicle as the vehicle to be charged that has reserved the target charging station and calculates the estimated time of arrival of the vehicle to be charged arriving at the target charging station as the estimated time of charging.

Additionally, an estimated charging quantity of the vehicle to be charged arriving at the target charging station is obtained. The estimated charging quantity may be a difference between an electric quantity when the vehicle to be charged is fully charged and an estimated state of charge when the vehicle arrives at the charging station. For example, the estimated charging quantity sent by the vehicle-machine system of the vehicle to be charged is received, and the estimated duration of charging may be obtained by dividing the estimated charging quantity by the charging rate of the charging pile of the target charging station.

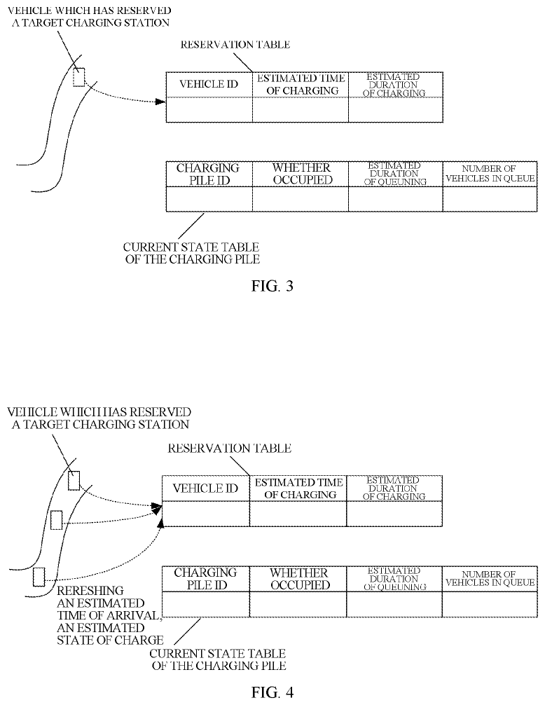

As an example, referring to FIG. 3, FIG. 3 is a first schematic diagram of the state of the charging pile according to an embodiment of the present disclosure. When a route navigation initiated on the target map application having the target charging station as the destination is detected, the vehicle that initiates the route navigation as the vehicle to be charged that has reserved the target charging station. Then the charging reservation information is determined and sent to the electronic device for maintaining the state of the charging pile in the target charging station. The electronic device may generate a reservation table for the vehicle to be charged, which may include a vehicle ID, an estimated time of charging, and estimated duration of charging. Additionally, the electronic device may also maintain a current state table of the charging pile, which may include the charging pile ID, whether the charging pile is occupied, estimated duration of queuing, and the number of vehicles in queue.

It can be seen that, in the embodiment of the present disclosure, the vehicle that has reserved the target charging station is determined based on the route navigation initiated on the target map application having the target charging station as the destination, so that a function of updating the state of the charging pile may be integrated into the map application and the vehicle does not need to interface with the electronic device for maintaining the state of the charging pile in the target charging station, which is more convenient.

Each target charging station may synchronize the estimated state of the charging pile thereof corresponding to the preset future period to the server of the target map application, so that the server of the target map application may store the estimated state of the charging pile of each target charging station in real time. That is, for the target vehicle that needs to be recommended a charging station, the estimated state of the charging pile of each target charging station may be obtained at any time through the target map application, which is very convenient and quick.

In an embodiment of the present disclosure, step S201 of determining the charging reservation information of the vehicle to be charged that has reserved the target charging station may include:

refreshing, at a preset refresh interval, the charging reservation information of the vehicle to be charged that has reserved the target charging station.

Specifically, considering the complexity of vehicle conditions on the road, the estimated time of arrival and the estimated charging quantity may change dynamically. Therefore, the charging reservation information may be recalculated at regular intervals, that is, the charging reservation information of the vehicle to be charged that has reserved the target charging station may be refreshed. The refresh interval may be set according to needs, for example, set to 1 minute.

As an example, referring to FIG. 4, FIG. 4 is a second schematic diagram of the state of the charging pile according to an embodiment of the present disclosure. In the process that the vehicle to be charged goes to the reserved target charging station, the estimated time of arrival and the estimated state of charge are refreshed at regular intervals to update the information in the corresponding reservation table. Accordingly, in combination with the current state table of the charging pile, the estimated state of the charging pile of the target charging station is recalculated.

It can be seen that, in the embodiment of the present disclosure, S201 and S202 are performed at a preset refresh interval, so as to refresh the charging reservation information and the estimated state of the charging pile of the target charging station. The accuracy of the charging reservation information and the estimated state of the charging pile are further improved, and calculation errors caused by unstable vehicle conditions on the road are reduced.

In an embodiment of the present disclosure, when it is detected that any vehicle to be charged changes the destination of the route navigation, the charging reservation information of the vehicle to be charged is removed, and the estimated state of the charging pile of the target charging station corresponding to the preset future period is updated.

Specifically, if any vehicle to be charged originally reserved a certain target charging station, but then the destination was changed, the charging reservation information of the vehicle to be charged needs to be removed. Accordingly, the estimated state of the charging pile of the target charging station corresponding to the preset future period is updated.

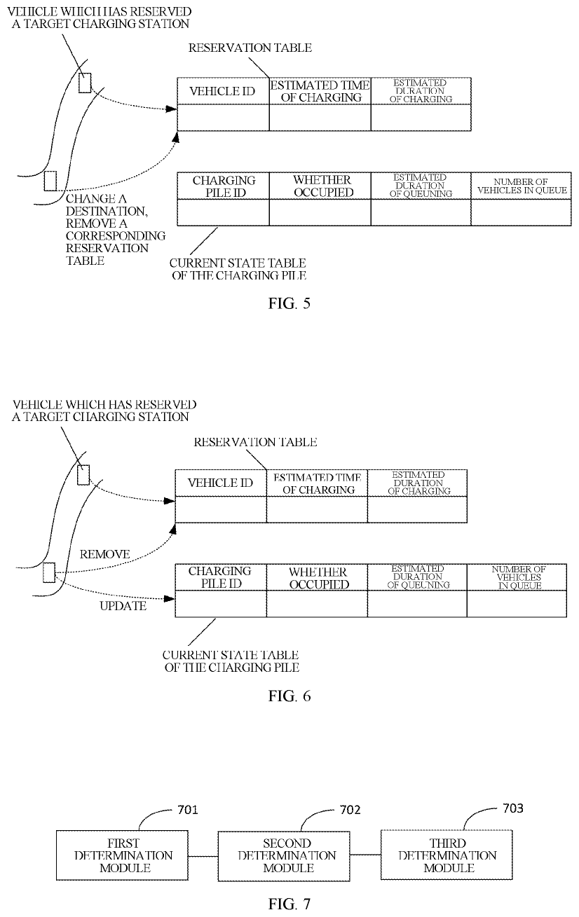

As an example, referring to FIG. 5, FIG. 5 is a third schematic diagram of the state of the charging pile according to an embodiment of the present disclosure. When it is detected that the vehicle to be charged, which originally reserved a certain target charging station, has changed the destination, the corresponding reservation table is removed. Accordingly, in combination with the current state table of the charging pile, the estimated state of the charging pile of the target charging station is recalculated.

It can be seen that, in the embodiment of the present disclosure, when it is detected that the vehicle that has made a reservation changes the destination, the corresponding charging reservation information is removed in time and the estimated state of the charging pile is refreshed, so as to further ensure the real-time performance of the charging reservation information and further improve the reliability of the estimated state of the charging pile.

In an embodiment of the present disclosure, when it is detected that any vehicle to be charged arrives at the target charging station, the charging reservation information of the vehicle to be charged is removed, and the current state of the charging pile of the target charging station and the estimated state of the charging pile corresponding to the preset future period are updated.

Specifically, if any vehicle to be charged arrives at the target charging station and starts charging, the current state of the charging pile of the target charging station needs to be updated and the charging reservation information of the vehicle to be charged is removed. According to the updated current state of the charging piles and current charging reservation information of other vehicles to be charged, the estimated state of the charging pile corresponding to the preset future period is recalculated.

As an example, referring to FIG. 6, FIG. 6 is a fourth schematic diagram of the state of the charging pile according to an embodiment of the present disclosure. When it is detected that the vehicle to be charged arrives at the target charging station, the reservation table corresponding to the vehicle to be charged is removed, and the current state of the charging pile of the target charging station is updated, so that the estimated state of the charging pile corresponding to the preset future period is refreshed.

It can be seen that, in the embodiment of the present disclosure, when it is detected that the vehicle to be charged arrives at the target charging station, the corresponding charging reservation information is removed in time, the current state of the charging pile of the target charging station is updated, and the estimated state of the charging pile is refreshed, so as to further ensure the real-time performance of the charging reservation information and further improve the reliability of the estimated state of the charging pile.

Referring to FIG. 7, FIG. 7 is a block diagram of an apparatus configured to implement the method for recommending the charging station according to the embodiment of the present disclosure, the apparatus including:

a first determination module 701 configured to determine candidate charging stations for a target vehicle;

a second determination module 702 configured to determine, for each candidate charging station, an estimated time of arrival of the target vehicle, and obtain an estimated state of a charging pile of the candidate charging station at the estimated time of arrival, where the estimated state of the charging pile is determined according to a current state of the charging pile and charging reservation information, and the charging reservation information includes: an estimated time of charging and estimated duration of charging of a vehicle to be charged that has reserved the candidate charging station; and a third determination module 703 configured to determine a target charging station from the candidate charging stations according to the obtained estimated states of the charging piles of each candidate charging station at the estimated time of arrival of the target vehicle, and recommend the target charging station for the target vehicle.

According to an embodiment of the present disclosure, the apparatus further includes:

a fourth determination module configured to determine, for each candidate charging station, estimated duration of traveling and estimated duration of charging of the target vehicle going to the candidate charging station for charging, where the estimated duration of charging is determined according to the estimated charging quantity of the target vehicle when it arrives at the candidate charging station;

the third determination module includes:

a first determination submodule configured to determine, for each candidate charging station, estimated duration of queuing of the target vehicle going to the candidate charging station for charging according to the obtained estimated states of the charging piles of the candidate charging station at the estimated time of arrival of the target vehicle;

a second determination submodule configured to determine a time cost of charging of the target vehicle going to each candidate charging station for charging according to the estimated duration of traveling, the estimated duration of queuing, and the estimated duration of charging; and

a selection submodule configured to select the target charging station from the candidate charging stations based on the time cost of charging.

According to an embodiment of the present disclosure, the selection submodule is configured to:

select, from the candidate charging stations, a charging station with a minimum time cost of charging as the target charging station.

According to an embodiment of the present disclosure, the apparatus further includes:

an obtaining submodule configured to obtain recommendation factors of each candidate charging station, the recommendation factors including: a position evaluation parameter, a vehicle owner preference parameter, and a total number of charging piles;

the selection submodule is configured to:

input, for each candidate charging station, the time cost of charging and the recommendation factors of the candidate charging station to a pre-trained recommendation model, to obtain a recommendation score for the candidate charging station;

select, from the candidate charging stations, a charging station with a maximum recommendation score as the target charging station.

It can be seen that, in the embodiment of the present disclosure, the charging station determines the estimated state of the charging pile corresponding to the preset future period based on the current state of the charging pile and the charging reservation information of the vehicle to be charged that has reserved the charging station. In combination with the estimated time when the target vehicle arrives at each candidate charging pile, the estimated state of the charging pile of each candidate charging station at respective estimated time of arrival (i.e., an estimated idle/occupied/queuing state of the charging pile when the target vehicle arrives) can be determined. Compared with the recommendation method based only on the current state of the charging pile of the candidate charging station, the recommendation method according to the present disclosure is more proper, so that the case can be avoided as much as possible where there are idle charging piles when the vehicle initiates navigation, but the charging piles are occupied when the vehicle arrives at the charging station. Unnecessary queuing of the owner of the electric vehicle is reduced as much as possible, a time cost of vehicle charging is decreased, and traveling experience of the owner of the electric vehicle is optimized.

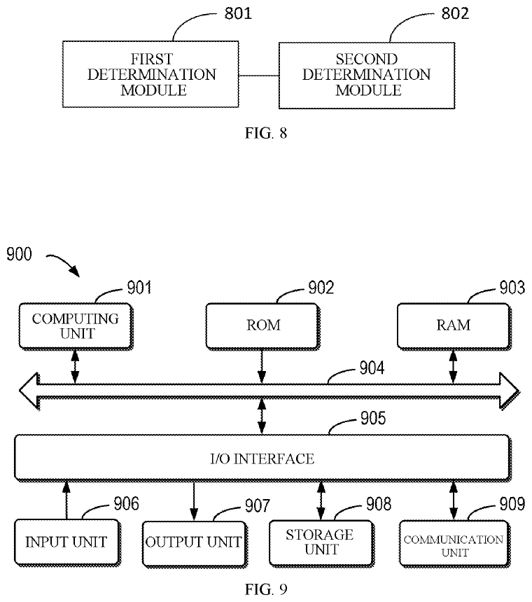

Referring to FIG. 8, FIG. 8 is a block diagram of an apparatus configured to implement the method for determining the state of the charging pile according to an embodiment of the present disclosure, the apparatus including:

a first determination module 801 configured to determine charging reservation information of a vehicle to be charged that has reserved a target charging station, the charging reservation information including: an estimated time of charging and estimated duration of charging; and

a second determination module 802 configured to determine an estimated state of the charging pile of the target charging station during a preset future period according to a current state of the charging pile of the target charging station and the charging reservation information of each vehicle to be charged.

According to an embodiment of the present disclosure, the first determination module 801 is configured to:

determine, when a route navigation initiated on a target map application having the target charging station as a destination is detected, a vehicle that initiates the route navigation as the vehicle to be charged that has reserved the target charging station, and determine the charging reservation information of the vehicle to be charged.

According to an embodiment of the present disclosure, the first determination module 801 is configured to:

refresh, at a preset refresh interval, the charging reservation information of the vehicle to be charged that has reserved the target charging station.

According to an embodiment of the present disclosure, the apparatus further includes:

a first change module configured to remove, when it is detected that any vehicle to be charged changes the destination of the route navigation, the charging reservation information of the vehicle to be charged, and update the estimated state of the charging pile of the target charging station corresponding to the preset future period; and

a second change module configured to remove, when it is detected that any vehicle to be charged arrives at the target charging station, the charging reservation information of the vehicle to be charged and update the current state of the charging pile of the target charging station and the estimated state of the charging pile corresponding to the preset future period.

It can be seen that, in the embodiment of the present disclosure, the charging reservation information including the estimated time of charging and the estimated duration of charging is determined for the vehicle to be charged that has reserved the target charging station. Moreover, according to the current state of the charging pile of the target charging station and the charging reservation information of each vehicle to be charged that has reserved the target charging station, the estimated state of the charging pile of the target charging station corresponding to the preset future period (i.e., the estimated idle/occupied/queuing state of the charging pile corresponding to the preset future period) is determined. Therefore, when recommending a charging station for the target vehicle, it is more proper to use the estimated state of the charging pile corresponding to the preset future period as the reference factor, compared with the recommendation method that only uses the current state of the charging pile as the reference factor. The situation can be avoided as much as possible where there are idle charging piles in the charging station when the vehicle initiates navigation, but the charging piles are all occupied when the vehicle arrives at the charging station. Unnecessary queuing up of the owner of the electric vehicle is reduced as much as possible, the time cost of vehicle charging is decreased, and traveling experience of the owner of the electric vehicle is optimized.

According to an embodiment of the present disclosure, an electronic device, a readable storage medium and a computer program product are further provided in the present disclosure.

The present disclosure provides an electronic device, including:

at least one processor; and

a memory in communication connection with the at least one processor, where

the memory stores instructions executable by the at least one processor that, when executed by the at least one processor, cause the at least one processor to perform the method for recommending a charging station or the method for determining a state of a charging pile.

A non-transitory computer-readable storage medium storing computer instructions is provided in the present disclosure, where the computer instructions are executed to cause the computer to perform the method for recommending a charging station or the method for determining a state of a charging pile.

A computer program product is provided in the present disclosure including computer programs that, when executed by a processor, cause to implement the method for recommending a charging station or the method for determining a state of a charging pile.

FIG. 9 is a schematic block diagram of an example electronic device 900 that may be used to implement the embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown herein, their connections and relationships, and their functions are merely examples, and are not intended to limit the implementation of the present disclosure described and/or required herein.

As shown in FIG. 9, the device 900 includes a computing unit 901, which may perform various appropriate actions and processing according to computer programs stored in a read-only memory (ROM) 902 or computer programs loaded from a storage unit 908 to a random access memory (RAM) 903. The RAM 903 may further store various programs and data required for the operations of the device 900. The computing unit 901, the ROM 902, and the RAM 903 are connected to each other via a bus 904. An input/output (I/O) interface 905 is also connected to the bus 904.

A plurality of components in the device 900 are connected to the I/O interface 905, including: an input unit 906, such as a keyboard or a mouse; an output unit 907, such as various types of displays or speakers; a storage unit 908, such as a magnetic disk or an optical disc; and a communication unit 909, such as a network card, a modem, a wireless communication transceiver, etc. The communication unit 909 allows the device 900 to exchange information/data with other devices through a computer network such as the Internet, and/or various telecommunications networks.

The computing unit 901 may be various general-purpose and/or special-purpose processing components with processing and computing capabilities. Some examples of the computing unit 901 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 901 performs the various methods and processing described above, for example, the method for recommending a charging station or the method for determining a state of a charging pile. For example, in some embodiments, the method for recommending a charging station or the method for determining a state of a charging pile may be implemented as computer software programs, which are tangibly included in a machine-readable medium, such as the storage unit 908. In some embodiments, a portion or all of the computer programs may be loaded and/or installed onto the device 900 via the ROM 902 and/or the communication unit 909. When the computer programs are loaded to the RAM 903 and executed by the computing unit 901, one or more steps of the method for recommending a charging station or the method for determining a state of a charging pile described above can be performed. Alternatively, in other embodiments, the computing unit 901 may be configured, in any other suitable manners (for example, by firmware), to perform the method for recommending a charging station or the method for determining a state of a charging pile.

Various implementations of the systems and technologies described herein above may be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include implementing the systems and technologies in one or more computer programs, wherein the one or more computer programs may be executed and/or interpreted on a programmable system including at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

Program codes for implementing the method of the present disclosure may be written in any combination of one or more programming languages. These program codes may be provided to processors or controllers of the general-purpose computer, the special-purpose computer, or other programmable data processing apparatuses, such that when the program codes are executed by the processors or the controllers, the functions/operations specified in the flowcharts and/or block diagrams are implemented. The program codes may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may include or store programs for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein may be implemented on a computer which has: a display apparatus (for example, a cathode-ray tube (CRT) or a liquid crystal display (LCD) monitor) configured to display information to the user; and a keyboard and a pointing apparatus (for example, a mouse or a trackball) through which the user can provide an input to the computer. Other types of apparatuses can also be used to provide interaction with the user; for example, feedback provided to the user can be any form of sensory feedback (for example, visual feedback, auditory feedback, or tactile feedback), and an input from the user can be received in any form (including an acoustic input, a voice input, or a tactile input).

The systems and technologies described herein may be implemented in a computing system including a backend component (for example, as a data server), or a computing system including a middleware component (for example, an application server), or a computing system including a frontend component (for example, a user computer with a graphical user interface or a web browser through which the user can interact with the implementations of the systems and technologies described herein), or a computing system including any combination of the backend component, the middleware component, or the frontend component. The components of the system can be connected to each other through digital data communication (for example, a communications network) in any form or medium. Examples of the communications network include: a local area network (LAN), a wide area network (WAN), and the Internet.

A computer system may include a client and a server. The client and the server are generally far away from each other and usually interact through a communications network. A relationship between the client and the server is generated through computer programs running on respective computers and having a client-server relationship with each other. The server may be a cloud server, a server in a distributed system, or a server combined with a blockchain.

It should be understood that steps may be reordered, added, or deleted based on the various forms of procedures described above. For example, the steps described in the present disclosure may be performed in parallel, in order, or in a different order, provided that the desired result of the technical solutions disclosed in the present disclosure can be achieved, which is not limited herein.

The specific implementations described above do not limit the scope of protection of the present disclosure. It will be apparent for those skilled in the art that various modifications, combinations, sub-combinations, and replacements can be made based on design requirements and other factors. Any modifications, equivalent replacements, improvements, etc. within the spirit and principle of the present disclosure shall fall within the scope of protection of the present disclosure.

What is claimed is:

1. A method, comprising:
determining a set of candidate charging stations for a target vehicle;
determining, for each candidate charging station in the set of candidate charging stations, an estimated time of arrival of the target vehicle, and obtaining an estimated state of a charging pile of the candidate charging station at the estimated time of arrival, wherein the estimated state of the charging pile of the candidate charging station is based on a current state of the charging pile and charging reservation information, and wherein the charging reservation information comprises: an estimated time of charging and estimated duration of charging of a vehicle to be charged that has reserved the candidate charging station; and
determining a target charging station from the set of candidate charging stations according to the obtained estimated states of the charging piles of the candidate charging stations in the set of candidate charging stations at the estimated times of arrival of the target vehicle, and recommending the target charging station for charging the target vehicle.

2. The method according to claim 1, further comprising:
determining, for each candidate charging station in the set of candidate charging stations, estimated duration of traveling to the candidate charging station and estimated duration of charging of the target vehicle going to the candidate charging station for charging, wherein the estimated duration of charging is determined according to an estimated charging quantity of the target vehicle arriving at the candidate charging station;
wherein determining the target charging station from the set of candidate charging stations comprises:
determining, for each candidate charging station in the set of candidate charging stations, estimated duration of queuing of the target vehicle going to the candidate charging station for charging according to the obtained estimated state of the charging pile of the candidate charging station at the estimated time of arrival of the target vehicle;
determining, for each candidate charging station in the set of candidate charging stations, a time cost of charging of the target vehicle going to the candidate charging station for charging according to the estimated duration of traveling to the candidate charging station, the estimated duration of queuing of the target vehicle going to the candidate charging station, and the estimated duration of charging of the target vehicle going to the candidate charging station for charging; and
selecting the target charging station from the set of candidate charging stations based on the time costs of charging.

3. The method according to claim 2, wherein selecting the target charging station from the set of candidate charging stations based on the time costs of charging comprises:
selecting, from the set of candidate charging stations, a charging station with a minimum time cost of charging as the target charging station.

4. The method according to claim 2, further comprising:
obtaining, for each candidate charging station in the set of candidate charging stations, one or more recommendation factors of the candidate charging station, wherein the one or more recommendation factors comprise: a position evaluation parameter, a vehicle owner preference parameter, and/or a total number of charging piles at the candidate charging stations;
wherein selecting the target charging station from the set of candidate charging stations based on the time costs of charging comprises:
inputting, for each candidate charging station in the set of candidate charging stations, the time cost of charging and the one or more recommendation factors of the candidate charging station to a pre-trained recommendation model to obtain a recommendation score of the candidate charging station; and
selecting, from the set of candidate charging stations, a charging station with a maximum recommendation score as the target charging station.

5. A method, comprising:
determining charging reservation information of one or more vehicles to be charged that have reserved a target charging station, wherein the charging reservation information for a given vehicle comprises: an estimated time of charging the given vehicle and estimated duration of charging the given vehicle; and
determining an estimated state of a charging pile of the target charging station corresponding to a preset future period according to a current state of the charging pile of the target charging station and the charging reservation information of the one or more vehicles to be charged.

6. The method according to claim 5, wherein determining the charging reservation information of the one or more vehicles to be charged comprises:
determining, based on a route navigation initiated on a target map application having the target charging station as a destination of the route navigation, a first vehicle that initiates the route navigation as a vehicle to be charged that has reserved the target charging station; and
determining the charging reservation information of the first vehicle.

7. The method according to claim 5, wherein determining the charging reservation information of the one or more vehicles to be charged comprises:
refreshing, at a preset refresh interval, the charging reservation information of the one or more vehicles to be charged that have reserved the target charging station.

8. The method according to claim 6, further comprising:
removing, based on detecting that a vehicle to be charged that has reserved the target charging station changes the destination of the route navigation, the charging reservation information of the vehicle to be charged, and updating the estimated state of the charging pile of the target charging station corresponding to the preset future period.

9. The method according to claim 5, further comprising:
removing, based on detecting that a vehicle to be charged that has reserved the target charging station arrives at the target charging station, the charging reservation information of the vehicle to be charged, and updating the current state of the charging pile of the target charging station and the estimated state of the charging pile corresponding to the preset future period.

10. An electronic device, comprising:
at least one processor; and
a memory in communication with the at least one processor, wherein the memory stores instructions executable by the at least one processor that, when executed by the at least one processor, cause the at least one processor to perform the method according to claim 1.

11. The electronic device according to claim 10, wherein the instructions, when executed by the at least one processor, further cause the at least one processor to:
determine, for each candidate charging station in the set of candidate charging stations, estimated duration of traveling to the candidate charging station and estimated duration of charging of the target vehicle going to the candidate charging station for charging, wherein the estimated duration of charging is determined according to an estimated charging quantity of the target vehicle arriving at the candidate charging station;
wherein determining the target charging station from the set of candidate charging stations comprises:
determining, for each candidate charging station in the set of candidate charging stations, estimated duration of queuing of the target vehicle going to the candidate charging station for charging according to the obtained estimated state of the charging pile of the candidate charging station at the estimated time of arrival of the target vehicle;
determining, for each candidate charging station in the set of candidate charging stations, a time cost of charging of the target vehicle going to the candidate charging station for charging according to the estimated duration of traveling to the candidate charging station, the estimated duration of queuing of the target vehicle going to the candidate charging station, and the estimated duration of charging of the target vehicle going to the candidate charging station for charging; and
selecting the target charging station from the set of candidate charging stations based on the time cost of charging.

12. The electronic device according to claim 11, wherein selecting the target charging station from the set of candidate charging stations based on the time cost of charging comprises:
selecting, from the set of candidate charging stations, a charging station with a minimum time cost of charging as the target charging station.

13. The electronic device according to claim 11, wherein the instructions, when executed by the at least one processor, further cause the at least one processor to:
obtain, for each candidate charging station in the set of candidate charging stations, one or more recommendation factors of the candidate charging station, wherein the one or more recommendation factors comprise: a position evaluation parameter, a vehicle owner preference parameter, and/or a total number of charging piles at the candidate charging station,
wherein selecting the target charging station from the set of candidate charging stations based on the time costs of charging comprises:
inputting, for each candidate charging station in the set of candidate charging stations, the time cost of charging and the one or more recommendation factors of the candidate charging station to a pre-trained recommendation model to obtain a recommendation score of the candidate charging station; and
selecting, from the set of candidate charging stations, a charging station with a maximum recommendation score as the target charging station.

14. An electronic device, comprising:
at least one processor; and
a memory in communication with the at least one processor, wherein the memory stores instructions executable by the at least one processor that, when executed by the at least one processor, cause the at least one processor to perform the method according to claim 5.

15. The electronic device according to claim 14, wherein determining the charging reservation information of the one or more vehicles to be charged comprises:
determining, based on a route navigation initiated on a target map application having the target charging station as a destination of the route navigation, a first vehicle that initiates the route navigation as a vehicle to be charged that has reserved the target charging station; and
determining the charging reservation information of the first vehicle.

16. The electronic device according to claim 14, wherein determining the charging reservation information of the one or more vehicles to be charged comprises:
refreshing, at a preset refresh interval, the charging reservation information of the one or more vehicles to be charged that have reserved the target charging station.

17. The electronic device according to claim 15, wherein the instructions, when executed by the at least one processor, further cause the at least one processor to:
remove, based on detecting that a vehicle to be charged that has reserved the target charging station changes the destination of the route navigation, the charging reservation information of the vehicle to be charged, and update the estimated state of the charging pile of the target charging station corresponding to the preset future period.

18. The electronic device according to claim 14, wherein the instructions, when executed by the at least one processor, further cause the at least one processor to:
remove, based on detecting that a vehicle to be charged that has reserved the target charging station arrives at the target charging station, the charging reservation information of the vehicle to be charged, and update the current state of the charging pile of the target charging station and the estimated state of the charging pile corresponding to the preset future period.

19. A non-transitory computer-readable storage medium storing computer instructions that, when executed by one or more processors, cause a computer to perform the method according to claim 1.

20. A non-transitory computer-readable storage medium storing computer instructions that, when executed by one or more processors, cause a computer to perform the method according to claim 5.
